(19) United States
(12) Patent Application Publication
(10) Pub. No.: US 2005/0071524 A1
(43) Pub. Date: Mar. 31, 2005

(54) System and method for manipulating and backing up CD/DVD information

(75) Inventors: Soul Liu, Chongqing (CN); Larry Tsai, Taipei (TW)

Correspondence Address: HOGAN & HARTSON L.L.P., 500 S. GRAND AVENUE, SUITE 1900, LOS ANGELES, CA, 90071-2611, US

(73) Assignee: FARSTONE TECH. INC.

(21) Appl. No.: 10/916,770

(22) Filed: Aug. 12, 2004

(30) Foreign Application Priority Data
Aug. 14, 2003 (TW) 92122313

(51) Int. Cl. G06F 3/00

(52) U.S. Cl. 710/15

(57) ABSTRACT

Methods and systems are provided for manipulating and backing up CD/DVD information. Unlike the conventional approach that relies on a CD/DVD emulating software installed on a hard disk, the invention does not need a physical CD/DVD running in a physical CD/DVD drive nor install the CD/DVD emulating software to the hard disk after data is copied to a removable media.

### BACKGROUND OF THE INVENTION

1. Field of the Invention

The present invention relates generally to a disk accessing technique for a computer system, and more particularly to a disk backup system and method that conveniently backs up every format of CD/DVD disk.

2. Description of Prior Art

Conventional data storage medium, such as a CD-ROM (Compact Disc Read-Only Memory), CD-R (Compact Disk-Recordable), CD-RW, DVD (Digital Versatile Disc), DVD-R or DVD-RW or the like, has advantages of high storage density, low cost, long life and high reliability and stability. However, such storage media are fragile and care must be taken to avoid scratching the disk. If you have disks you really don't want to lose, make sure you back data up.

Conventional disk backup techniques can be classified into burning a disk with a disk burner and backing up disk image files.

The burning disk type backup technique, such as the Nero burning software operating with the BenQ disk burner, backs up merely the CD/DVD in ISO format. If the CD/DVD disk is in special format, the backup operation would be failed. Moreover, the data backed up by the burning technique occupies an extremely large space, and the remaining space will not be in use by another data storage medium. Accordingly, the storage space will be waste.

The image file type backup technique copies an entire CD/DVD disk into a disk-image file that resides on your hard drive. When manipulating the image file, the CD/DVD emulator emulates your computer's CD/DVD-ROM drive, which enables you to run CD/DVD programs directly from your hard drive without the use of the physical CD/DVD-ROM drive or the actual disc. The image file is just inserted into the virtual CD/DVD-ROM drive to run it.

The image file type backup technique even though supports the special format CD/DVD disk, the backup technique has some major drawbacks. The backed up data can only be manipulated in the Windows computer with the CD/DVD emulating software installed therein. Meanwhile, the operating interface is quite complicated.

On the other hand, the users can not run the disk-image file in another computer without installing the emulating software. In addition, there are concerns about the hard drive, such as space consuming and easily destroyed, for the conventional image file type backup technique. It would be difficult for the users to attempt to keep a long-term backup.

### SUMMARY OF THE INVENTION

The present invention provides a backup system and manipulating method to resolve the foregoing problems faced by the conventional CD/DVD emulator. The present invention also has the advantage of providing a long backup period and a high reliability.

An object of the present invention is to provide a backup system and method, wherein the users can copy several CD/DVD disks into a single disk in a compress way.

Another object of the present invention is to provide a backup system and method, wherein the backed up CD/DVD disks can be manipulated in every computer with/ without the CD/DVD emulating software.

A further object of the present invention is to provide a backup system and method, which can eliminate the learning on the operating interface, to achieve the highest convenience and user acceptability.

In accordance with an aspect of the present invention, a disk accessing system is used for accessing disk data without inserting the disk. The disk accessing system is a removable media, which comprises a predetermined file and an emulating unit. The predetermined file has data contained in the disk. The emulating unit emulates a CD-ROM drive accessing the predetermined file. The emulating unit accesses the predetermined file and emulates to the disk. In the preferred embodiment of the invention, the removable media may include a compact disk (CD), a DVD, or a MO, which may be located in a CD/DVD-ROM drive. The CD-ROM is coupled to a computer system. The computer system installs a CD/DVD-ROM emulator. The CD/DVD-ROM emulator includes a simulating module and a mounting/rejecting module. The simulating module is used for simulating a CD/DVD-ROM drive accessing the predetermined file. The mounting/rejecting module is used for accessing the predetermined file into/from the emulating unit. The computer system installs a burning software for burning the simulating module, the mounting/rejecting module and the predetermined file onto a recordable media. The disk is selected from the group consisting of Copy-Protected CD, audio CD, Video CD, Data CD, Photo CD, Multi-Session CD, Data DVD, Audio DVD, mixed mode CD, and CD Extra. The amount of the disk is greater than or equal to one.

In accordance with another aspect of the present invention, a disk backup system is installed in a computer system. The disk backup system backs up at least one disk in a removable media. The disk backup system comprises a first processing device, an emulating unit and a second processing device. The first processing device is used for processing data contained in the disk into a predetermined file. The emulating unit is used for emulating a CD-ROM drive accessing the predetermined file. The second processing device is used for processing the predetermined file and the emulating unit onto the removable media.

In the preferred embodiment of the invention, the removable media is a recordable media. The computer system installs a burning software. The disk is selected from the group consisting of Copy-Protected CD, audio CD, Video CD, Data CD, Photo CD, Multi-Session CD, Data DVD, Audio DVD, mixed mode CD, and CD Extra. The amount of the disk is greater than or equal to one.

In accordance with a further aspect of the present invention, a backup method is suitable for a computer system. The backup method is used for backing up at least one disk in a removable media. The backup method comprises the steps of: processing data contained in the disk into a predetermined file; and processing the predetermined file and an emulating unit onto the removable media.

In the preferred embodiment of the invention, the backup method further comprises the step of accessing the predetermined file and emulating the predetermined file into the disk. The emulating unit emulates a CD-ROM drive accessing the predetermined file. The predetermined file is mounted/rejected into/from the emulating unit. The computer system installs a burning software.

The present invention may best be understood through the following description with reference to the accompanying drawings, in which:

### BRIEF DESCRIPTION OF THE DRAWINGS

FIG. 1 shows a schematic block diagram of a computer system of a preferred embodiment according to the present invention.

FIG. 2 shows a schematic flow chart of a backup method of the preferred embodiment according to the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for the purpose of illustration and description only. It is not intended to be exhaustive or to be limited to the precise form disclosed.

The present invention describes a new backup technique for every format of CD/DVD disk to preserve the disk-image file in a removable media, such as a compact disk (CD), a DVD (Digital Versatile Disk) or a MO or the like, which can solve the problem of wasting hard drive storage space. Moreover, the users will have no confusion and difficulty in operating the presently described backup system. Accordingly, the presently described backup system, thus, serves users' demands much more adequately. With the backup technique of the present invention, the users can keep the backup of disk data timelessly. Therefore, the drawbacks faced by the prior arts can be solved completely.

According to the preferred embodiment of the present invention, a disk accessing system is used for accessing disk data without inserting the disk. The disk accessing system is a removable media, which comprises a predetermined file and an emulating unit. The predetermined file has data contained in the disk. The emulating unit emulates a CD-ROM drive accessing the predetermined file. The emulating unit accesses the predetermined file and emulates to the disk.

The removable media may include a compact disk (CD), a DVD, or a MO, which may be located in a CD/DVD-ROM drive. The CD-ROM is coupled to a computer system. The computer system installs a CD/DVD-ROM emulator. The CD/DVD-ROM emulator includes a simulating module and a mounting/rejecting module. The simulating module is used for simulating a CD/DVD-ROM drive accessing the predetermined file. The mounting/rejecting module is used for accessing the predetermined file into/from the emulating unit. The computer system installs a burning software for burning the simulating module, the mounting/rejecting module and the predetermined file onto a recordable media. The disk is selected from the group consisting of Copy-Protected CD, audio CD, Video CD, Data CD, Photo CD, Multi-Session CD, Data DVD, Audio DVD, mixed mode CD, and CD Extra. The amount of the disk is greater than or equal to one.

According to the preferred embodiment of the present invention, a disk backup system is installed in a computer system. The disk backup system backs up at least one disk in a removable media. The disk backup system comprises a first processing device, an emulating unit and a second processing device. The first processing device is used for processing data contained in the disk into a predetermined file. The emulating unit is used for emulating a CD-ROM drive accessing the predetermined file. The second processing device is used for processing the predetermined file and the emulating unit onto the removable media.

The removable media is a recordable media. The computer system installs a burning software. The disk is selected from the group consisting of Copy-Protected CD, audio CD, Video CD, Data CD, Photo CD, Multi-Session CD, Data DVD, Audio DVD, mixed mode CD, and CD Extra. The amount of the disk is greater than or equal to one.

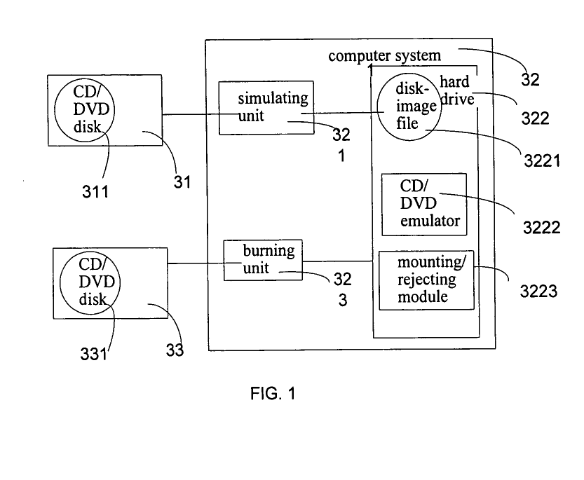

Referring to FIG. 1, a schematic block diagram of a computer system of a preferred embodiment according to the present invention is shown. The disk accessing system and the backup system of the present invention is suitable for a computer system 32. The computer system 32 is coupled to a CD/DVD-ROM drive 31 and a CD/DVD-ROM drive with burning function 33. There is a CD/DVD disk 311 and a disk accessing system 331 inserted in the CD/DVD-ROM drive 31 and 33 respectively.

The CD/DVD disk 311 contains data and information needed to be preserved over a long period of time. The CD/DVD disk 311 is selected from the group consisting of Copy-Protected CD, audio CD, Video CD, Data CD, Photo CD, Multi-Session CD, Data DVD, Audio DVD, mixed mode CD, and CD Extra. The amount of the disk is greater than or equal to one. The disk accessing system 331 is a removable media. Data and information can be copied to the disk accessing system 331.

The computer system 32 has a simulating unit 321, a hard drive 322 and a burning unit 323. The hard drive 322 includes at least a disk-image file 3221 and an emulating unit. The emulating unit may have a CD/DVD emulator 3222 and a mounting/rejecting module 3223. The disk-image file 3221 has data contained in the CD/DVD disk 311.

The simulating module 321 is used for simulating a CD/DVD-ROM drive accessing the disk-image file 3221. The simulating unit 321 creates the CD/DVD disk 311 in the CD/DVD-ROM drive 31 and the disk-image file 3221, and stores the disk-image file 3221 in the hard drive 322.

The burning unit 323 is used for burning data and program onto a recordable media. The burning unit 323 copies the emulating unit and the disk-image file 3221 into the disk accessing system 331 that inserted in the CD/DVD-ROM drive with burning function 33. The disk accessing system 331 is used for accessing disk data without inserting the CD/DVD disk 311. The removable media may include a compact disk (CD), a DVD, or a MO, which may be located in a CD/DVD-ROM drive.

The emulating unit includes at least a mounting/rejecting module 3223. The mounting/rejecting module 3223 is used for accessing the disk-image file 3221 into/from the emulating unit. A CD/DVD emulator 3222 accessing the disk-image file 3221 may be emulated by the emulating unit as necessary. The emulating unit can access the disk-image file 3221 and emulates to the data contained in the CD/DVD disk 311.

The mounting/rejecting module 3223 detects whether the CD/DVD emulator 3222 has installed in the computer system 32. If not, the mounting/rejecting module 3223 installs the CD/DVD emulator 3222 in the computer system 32.

According to another preferred embodiment of the present invention, a disk backup system is installed in a computer system 32. The disk backup system backs up at least one disk in a removable media. The disk backup system comprises a first processing device, an emulating unit and a second processing device. The first processing device may include the simulating unit 321, for processing data contained in the CD/DVD disk 311 into the disk-image file 3221. The emulating unit is used for emulating a CD-ROM drive accessing the disk-image file 3221. The second processing device may include the burning unit 323, for processing the disk-image file 3221 and the emulating unit onto the removable media.

The removable media is a recordable media. The computer system 32 installs a burning software. The disk is selected from the group consisting of Copy-Protected CD, audio CD, Video CD, Data CD, Photo CD, Multi-Session CD, Data DVD, Audio DVD, mixed mode CD, and CD Extra. The amount of the CD/DVD disk 311 is greater than or equal to one.

According to further embodiment of the present invention, a backup method is suitable for a computer system. The backup method is used for backing up at least one disk in a removable media. The backup method comprises the steps of: processing data contained in the disk into a predetermined file; and processing the predetermined file and an emulating unit onto the removable media.

The backup method further comprises the step of accessing the predetermined file and emulating the predetermined file into the disk. The emulating unit emulates a CD-ROM drive accessing the predetermined file. The predetermined file is mounted/rejected into/from the emulating unit. The computer system installs a burning software.

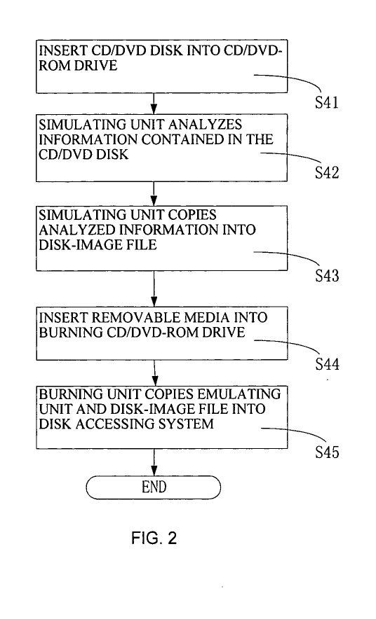

Referring to FIG. 2, a schematic flow chart of a backup method of the preferred embodiment according to the present invention is shown. According to the present invention, the backup method of the present invention is suitable for a computer system 32. The backup method is used for backing up at least one CD/DVD disk 311 in a removable media.

As shown in FIG. 2, the backup method comprises the steps of: processing data contained in the CD/DVD disk 311 into a disk-image file 3221; and processing the disk-image file 3221 and an emulating unit onto the removable media, such as a compact disk (CD), a DVD or a MO or the like.

The emulating unit emulates a CD-ROM drive accessing the disk-image file 3221. The disk-image file 3221 is mounted/rejected into/from the emulating unit. The computer system 32 installs a burning software.

Step S41, is to insert the CD/DVD disk 311 into the CD/DVD-ROM drive 31. In step S42, the simulating unit 321 analyzes information contained in the CD/DVD disk 311. In step S43, the simulating unit 321 copies the analyzed information into a disk-image file that resides on the hard drive 322. Step S44, is to insert the removable media into the CD/DVD-ROM drive with burning function 33. In step S45, The burning unit 323 copies the emulating unit and the disk-image file 3221 into the disk accessing system 331 that inserted in the CD/DVD-ROM drive with burning function 33.

The disk accessing system 331 can be manipulated in every computer with/without any CD/DVD emulator installed therein. When manipulating the disk accessing system 331, the mounting/rejecting module 3223 detects whether the CD/DVD emulator 3222 has installed in the computer system 32. If not, the mounting/rejecting module 3223 installs the CD/DVD emulator 3222 in the computer system 32. Then the disk-image file 3221 is accessed and emulated into the CD/DVD disk 311.

As shown in this figure, the user generally is not involved in executing the operation. Hence, the user can conveniently run the backed up file without learning on the operating interface, to achieve the highest convenience and user acceptability.

The disk-image file 3221 according to the present invention may have data contained in a plurality of CD/DVD disks 311. The present invention puts the emulating unit and the disk-image file 3221 into the disk accessing system 331 independent of the computer system 32 so that the removable media can effectively solved the storage shortage problem of the computer system 32 faced by the conventional CD/DVD emulating software. Accordingly, the shortcoming that the users cannot keep a long-term backup can be entirely avoided.

Furthermore, by using the disk backup system of the present invention, the data can be protected timelessly within a removable media. Hence, the backup system of the present invention not only can backup every special format of CD/DVD disk but also can economize on the storage space of the hard drive.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A disk accessing system, which is a removable media, for accessing disk data without inserting said disk, said disk accessing system comprising:
a predetermined file having data contained in said disk; and
an emulating unit for emulating a CD-ROM drive accessing said predetermined file,
wherein said emulating unit accesses said predetermined file and emulates to said disk.

2. The disk accessing system according to claim 1, wherein said removable media may include a compact disk (CD), a DVD, or a MO.

3. The disk accessing system according to claim 1, wherein said removable media may be located in a CD/DVD-ROM drive.

4. The disk accessing system according to claim 3, wherein said CD-ROM is coupled to a computer system.

5. The disk accessing system according to claim 4, wherein said computer system installs a CD/DVD-ROM emulator.

6. The disk accessing system according to claim 5, wherein said CD/DVD-ROM emulator includes a simulating module for simulating a CD/DVD-ROM drive accessing said predetermined file and a mounting/rejecting module for accessing said predetermined file into/from said emulating unit.

7. The disk accessing system according to claim 6, wherein said computer system installs a burning software for burning said simulating module, said mounting/rejecting module and said predetermined file onto a recordable media.

8. The disk accessing system according to claim 1, wherein said disk is selected from the group consisting of Copy-Protected CD, audio CD, Video CD, Data CD, Photo CD, Multi-Session CD, Data DVD, Audio DVD, mixed mode CD, and CD Extra.

9. The disk accessing system according to claim 1, wherein the amount of said disk is greater than or equal to one.

10. A disk backup system for backing up at least one disk in a removable media, which is installed in a computer system, said disk backup system comprising:
a first processing device for processing data contained in said disk into a predetermined file;
an emulating unit for emulating a CD-ROM drive accessing said predetermined file; and
a second processing device for processing said predetermined file and said emulating unit onto said removable media.

11. The disk backup system according to claim 10, wherein said removable media is a recordable media.

12. The disk backup system according to claim 10, wherein said computer system installs a burning software.

13. The disk backup system according to claim 10, wherein said disk is selected from the group consisting of Copy-Protected CD, audio CD, Video CD, Data CD, Photo CD, Multi-Session CD, Data DVD, Audio DVD, mixed mode CD, and CD Extra.

14. The disk backup system according to claim 10, wherein the amount of said disk is greater than or equal to one.

15. A backup method for backing up at least one disk in a removable media, suitable for a computer system, said backup method comprising the steps of:
processing data contained in said disk into a predetermined file; and
processing said predetermined file and an emulating unit onto said removable media.

16. The backup method according to claim 15, further comprising the step of accessing said predetermined file and emulating said predetermined file into said disk.

17. The backup method according to claim 15, wherein said emulating unit emulates a CD-ROM drive accessing said predetermined file.

18. The backup method according to claim 15, wherein said predetermined file is mounted/rejected into/from said emulating unit.

19. The backup method according to claim 15, wherein said computer system installs a burning software.
